(19) United States
(12) Patent Application Publication
(10) Pub. No.: US 2015/0371207 A1
(43) Pub. Date: Dec. 24, 2015

(54) METHOD AND SYSTEM FOR VARIABILITY OF AGGREGATED PAYMENTS BASED ON ACCOUNT TRUSTWORTHINESS

(71) Applicant: MasterCard International Incorporated, Purchase, NY (US)

(72) Inventors: Oran CUMMINS, Dublin (IE); David BROWN, Dardenne Prairie, MO (US)

(73) Assignee: MASTERCARD INTERNATIONAL INCORPORATED, Purchase, NY (US)

(21) Appl. No.: 14/744,425

(22) Filed: Jun. 19, 2015

Related U.S. Application Data
(60) Provisional application No. 62/014,921, filed on Jun. 20, 2014.

(51) Int. Cl. G06Q 20/22

(52) U.S. Cl. CPC G06Q 20/22

(57) ABSTRACT

A method for intelligently aggregating payment transactions based on consumer trustworthiness includes: storing an account profile, the profile including data related to a consumer including an account identifier, payment details, and a trustworthiness score; identifying a period of time for transaction aggregation based on the trustworthiness score included in the account profile; receiving transaction data for a plurality of payment transactions, the transaction data for each transaction including the account identifier, a transaction amount, and a transaction time and/or date; aggregating the transaction amount included in the transaction data in each payment transaction of the plurality of payment transactions where the included transaction time and/or date is within the identified period of time; and transmitting the aggregated transaction amount and the payment details included in the account profile for use in processing an aggregated payment transaction.

### FIELD

The present disclosure relates to the intelligent aggregation of payment transactions, specifically the use of account trustworthiness to determine variable periods for aggregation of payment transactions, particularly for micropayments.

### BACKGROUND

Merchants that regularly transact with a particularly consumer, especially over a relatively short period of time (e.g., hours or days), may sometimes aggregate transactions for the consumer over the period of time and then process a single, aggregated transaction. This may be especially true for instances where the transactions are payment transactions for small amounts, or micropayments. For example, many online retailers that sell music to consumers often aggregate transactions over a period of time (e.g., 3 days) as each transaction is often for a low amount (e.g., 99 cents).

By aggregating transactions over time into a single transaction, these merchants can process a significantly smaller number of transactions, and therefore cut down on the fees paid as part of the transaction processing process. For instance, if a consumer of the online music retailer purchases six different songs at 99 cents each during an aggregation period, the retailer may process a single transaction for $5.94 at the end of the period rather than six separate transactions for $0.99 each. This can result in significant savings for the merchant, particularly when multiplied by hundreds or thousands of consumers.

However, aggregating transactions may be dangerous for merchants in some instances. For example, if a consumer fails to satisfy payment for an aggregated transaction, the merchant may be out a much larger amount than if the consumer had failed to satisfy payment on a first transaction, and then subsequent transactions denied. For instance, in the online music retailer example, if the consumer failed payment on the first $0.99 cent transaction, the merchant may prohibit the consumer from engaging in the subsequent five transactions and save the $4.95 that would have otherwise been lost from the aggregated transaction.

Thus, there is a need for a technical solution to introduce variability in the aggregating of payment transactions and intelligently aggregate the transactions based on consumer trustworthiness.

### SUMMARY

The present disclosure provides a description of systems and methods for inferring a merchant geolocation.

A method for intelligently aggregating payment transactions based on consumer trustworthiness includes: storing, in an account database, an account profile, wherein the account profile includes data related to a consumer including at least an account identifier, payment details, and a trustworthiness score; identifying, by a processing device, a period of time for transaction aggregation based on at least the trustworthiness score included in the account profile; receiving, by a receiving device, transaction data for a plurality of payment transactions, wherein the transaction data for each payment transaction of the plurality of payment transactions includes at least the account identifier, a transaction amount, and a transaction time and/or date; aggregating, by the processing device, the transaction amount included in the transaction data in each payment transaction of the plurality of payment transactions where the included transaction time and/or date is within the identified period of time; and transmitting, by a transmitting device, at least the aggregated transaction amount and the payment details included in the account profile for use in processing an aggregated payment transaction.

A system for intelligently aggregating payment transactions based on consumer trustworthiness includes an account database, a processing device, a receiving device, and a transmitting device. The account database is configured to store an account profile, wherein the account profile includes data related to a consumer including at least an account identifier, payment details, and a trustworthiness score. The processing device is configured to identify a period of time for transaction aggregation based on at least the trustworthiness score included in the account profile. The receiving device is configured to receive transaction data for a plurality of payment transactions, wherein the transaction data for each payment transaction of the plurality of payment transactions includes at least the account identifier, a transaction amount, and a transaction time and/or date. The processing device is further configured to aggregate the transaction amount included in the transaction data in each payment transaction of the plurality of payment transactions where the included transaction time and/or date is within the identified period of time. The transmitting device is configured to transmit at least the aggregated transaction amount and the payment details included in the account profile for use in processing an aggregated payment transaction.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a high level architecture illustrating a system for the intelligent aggregation of payment transactions based on consumer trustworthiness in accordance with exemplary embodiments.

FIG. 2 is a block diagram illustrating the processing server of FIG. 1 for the intelligent aggregation of payment transactions in accordance with exemplary embodiments.

FIG. 3 is a diagram illustrating the aggregation of consumer transactions based on trustworthiness in accordance with exemplary embodiments.

FIG. 4 is a flow diagram illustrating a process for the intelligent aggregation of payment transactions using the system of FIG. 1 in accordance with exemplary embodiments.

FIG. 5 is a flow diagram illustrating a process for the intelligent aggregation of payment transactions using the processing server of FIG. 2 in accordance with exemplary embodiments.

FIG. 6 is a flow chart illustrating an exemplary method for intelligently aggregating payment transactions based on consumer trustworthiness in accordance with exemplary embodiments.

FIG. 7 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Glossary of Terms

Payment Network—A system or network used for the transfer of money via the use of cash-substitutes. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, financial accounts, etc. Examples of networks or systems configured to perform as payment networks include those operated by MasterCard®, VISA®, Discover®, American Express®, etc. Use of the term “payment network” herein may refer to both the payment network as an entity, and the physical payment network, such as the equipment, hardware, and software comprising the payment network.

### System for Intelligently Aggregating Payment Transactions

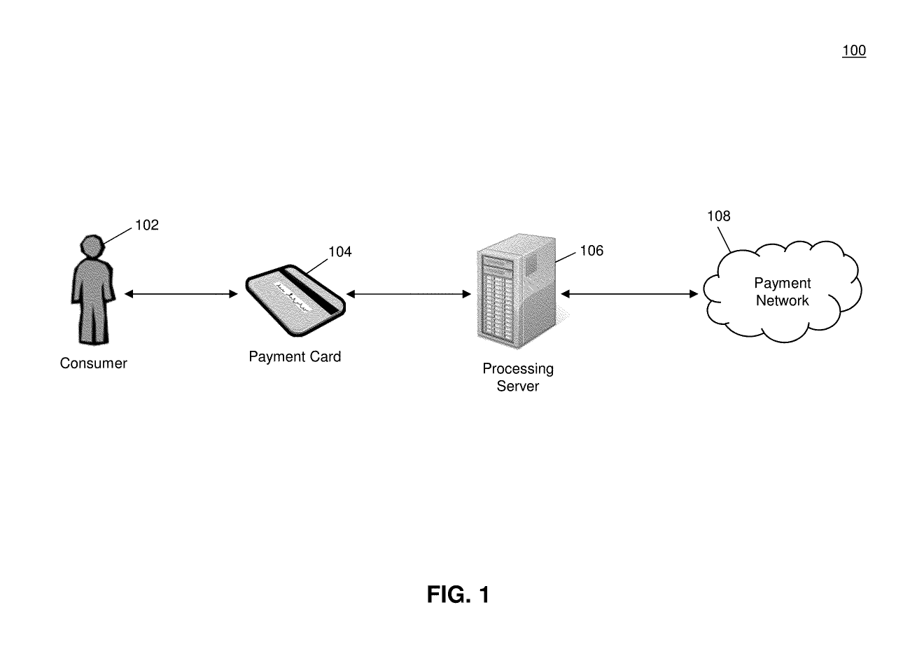

FIG. 1 illustrates a system 100 for the intelligent aggregation of payment transactions based on consumer trustworthiness.

The system 100 may include a consumer 102. The consumer 102 may use a payment card 104 to engage in a payment transaction with a merchant. Transaction data for the payment transaction, including payment details for the payment card 104, may be entered into a processing server 106. The processing server 106, discussed in more detail below, may be a part of the computing system of the merchant involved in the payment transaction and may be configured to intelligently aggregate payment transactions involving the consumer 102 using the methods and systems discussed herein. For example, the processing server 106 may be a part of a point of sale system configured to communicate with a payment network (e.g., via payment rails) using associated protocols or a part thereof.

The processing server 106 may identify an account identifier for the consumer 102 upon receipt of the transaction data for the first payment transaction. In some embodiments, the account identifier may be an account number or other suitable identification value read from the payment card 104 used to fund the payment transaction. In other embodiments, the consumer 102 may provide an alternative form of identification that may be suitable for identification of the consumer 102 and/or the transaction account used to fund the payment transactions, such as a username, e-mail address, phone number, device media access control address, etc.

The processing server 106 may then identify a trustworthiness score for the consumer 102. In some embodiments, the trustworthiness score may be received from a payment network 108 configured to process transactions involving the consumer 102. In such an embodiment, the processing server 106 may provide the account identifier corresponding to the consumer 102 to the payment network 108, such as using the payment rails or an alternative suitable communication network, such as the Internet. The payment network 108 may then identify data associated with the consumer 102 using the account identifier that may be suitable for the calculation of the trustworthiness score. In other embodiments, the processing server 106 may be configured to calculate the trustworthiness score. In some instances, the processing server 106 may be a part of the payment network 108.

The trustworthiness score may be based on data associated with the consumer 102 that may be suitable for the calculation of a score that represents the likelihood that the associated consumer 102 will successfully fund the payment transaction. For instance, the trustworthiness score may be, or may be based on at least one of: the consumer's 102 credit score, FICO score, purchase behavior (e.g., based on consumer transaction history) at all merchants and/or with the merchant involved in the transaction, a fraud score, etc. In some instances, the trustworthiness score may be based on a calculated or estimated risk score for the initial payment transaction, such as calculated by the payment network 108 or third party (e.g., issuing or acquiring financial institution), or based on a value that is based on the initial payment transaction (e.g., representative of aggregate transactions).

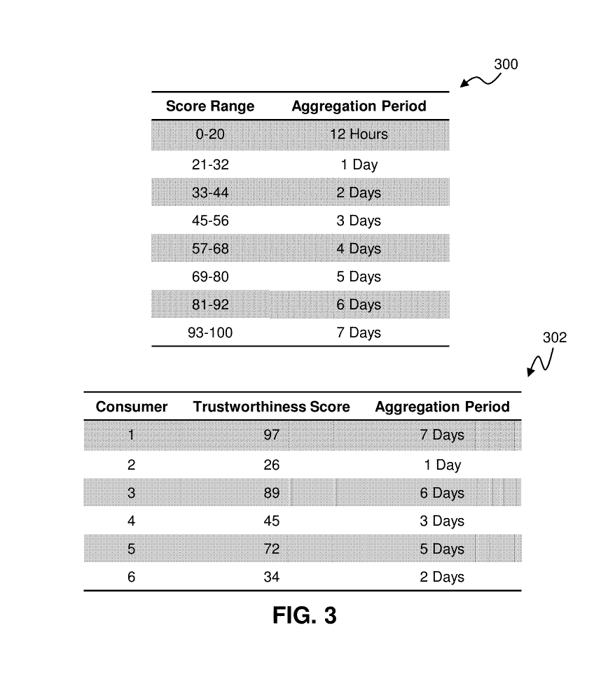

The processing server 106 may then identify an aggregation period for use in aggregating payment transactions involving the consumer 102 based on their trustworthiness score. The identification of an aggregation period based on a trustworthiness score is discussed in more detail below and illustrated in FIG. 3. The processing server 106 may aggregate all payment transactions involving the consumer 102 during the aggregation period, and may then aggregate them into one or more transactions. The aggregated transaction or transactions may then be submitted (e.g., in one or more authorization requests generated by the processing server 106 or a third party, such as an acquiring bank associated with the merchant) to the payment network 108 for processing using traditional methods and systems that will be apparent to persons having skill in the relevant art.

In some embodiments, the payment network 108 or other third party that may be configured to calculate the trustworthiness score for the consumer 102 may be further configured to provide a recommended aggregation period to the processing server 106. In such an embodiment, the aggregation period may be based on at least the calculated trustworthiness score and may be used by the processing server 106 in the identification of the actual aggregation period to be used. In some instances, the recommended aggregation period, or actual aggregation period used, may also be based on additional criteria, such as a merchant category of the merchant, preferences of the consumer 102, total transaction amount, and other criteria that will be apparent to persons having skill in the relevant art. For example, the aggregation period may be based on transaction history for the consumer 102, such as based on a common schedule of payment transactions by the consumer 102 with the merchant.

For example, a Laundromat, where consumers may conduct the majority of their transactions during a single day with proportionally large breaks between sets of transactions, may have aggregation periods recommended that are 24 hours or less. Conversely, an online music retailer, where consumers may regularly purchase music on a daily basis, may have aggregation periods recommended that are much longer. In another example, a particular consumer 102 may request that an aggregation period not exceed a specified time (e.g., 5 days), such based on their own preferences for monitoring their account usage. In yet another example, aggregation periods may include both time and amount, such that aggregation may be stopped at the earliest of three days or when the aggregated transaction amount exceeds $20. In such an instance, the amount may be based on the account trustworthiness score, the consumer's 102 preference, or the preference of the merchant. In some embodiments, the processing server 106 may use a combination of time-based and amount-based aggregation. For instance, the processing server 106 may aggregate all payment transactions involving the consumer 102 during the period of time, but may limit each aggregated transaction to the specified amount.

Aggregation of payment transactions may include the receipt of transaction messages for each individual transaction and use of data included therein for the generation of a subsequent transaction message associated with the aggregate payment transaction. For example, the processing server 106 may receive a transaction message formatted pursuant to one or more associated standards, such as the International Organization for Standardization's ISO 8583 standard, for each transaction. Each transaction message may include a plurality of data elements configured to store data as specified by the associated standards, such as a data element configured to store a transaction amount. The processing server 106 may add up the transaction amount stored in the respective data element in each transaction message and may, for the aggregate transaction, generate a transaction message and store the aggregated transaction amount in the respective data element in the generated transaction message.

In some instances, the processing server 106 may be configured to provide additional services to the consumer 102 regarding aggregation. For instance, the consumer 102 may request alerts regarding the aggregation period and the aggregated transaction amount. For example, the processing server 106 may provide updates to the consumer 102 regarding the amount of time until the aggregation period ends and the transaction processed, the current aggregated transaction amount, and the estimated transaction amount at the end of the aggregation period. The estimated transaction amount may be based on the consumer's 102 current aggregated transaction amount, the transactions being aggregated during the period, and/or the consumer's 102 transaction history with the merchant. Alerts and other notifications may be provided to the consumer 102 via any suitable method. For example, the processing server 106 may transmit the information to the consumer as a data signal to a computing device associated with the consumer 102, such as a mobile communication device (e.g., a smart phone, cellular phone, smart watch, wearable computing device, etc.) or other suitable device, via one or more communication methods using associated communication protocols. For instance, the signal may be transmitted to the consumer device via the Internet, a cellular communication network, radio frequency, local area network, etc.

By intelligently varying the aggregation period of transactions, particularly micropayment transactions, the methods and systems discussed herein may be advantageous for both consumers and merchants. Merchants may process less payment transactions for more trustworthy consumers, and thereby lose less revenue from transaction processing fees, while at the same time processing transactions sooner for less trustworthy consumers and prevent unpaid aggregate transactions before they may otherwise occur. Consumers may also realize convenience at having less transactions, and thereby less alerts, updates, receipts, and notifications, and may also realize savings as a result of the savings provided to the merchant by being trustworthy. In addition, the ability for the processing server 106 to provide variable aggregation periods may enable the processing server 106 to offer the consumer 102 to provide input regarding their preference for their aggregation period, which may provide consumers 102 with even more convenience.

### Processing Server

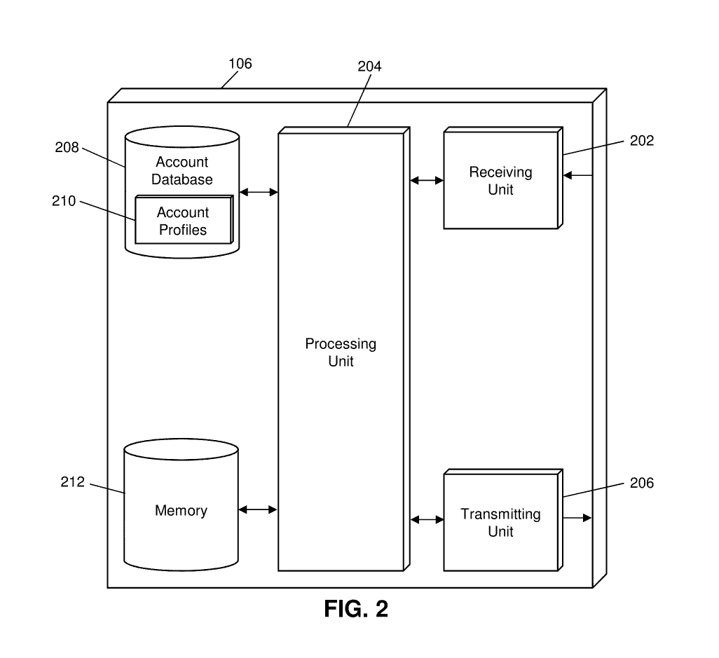

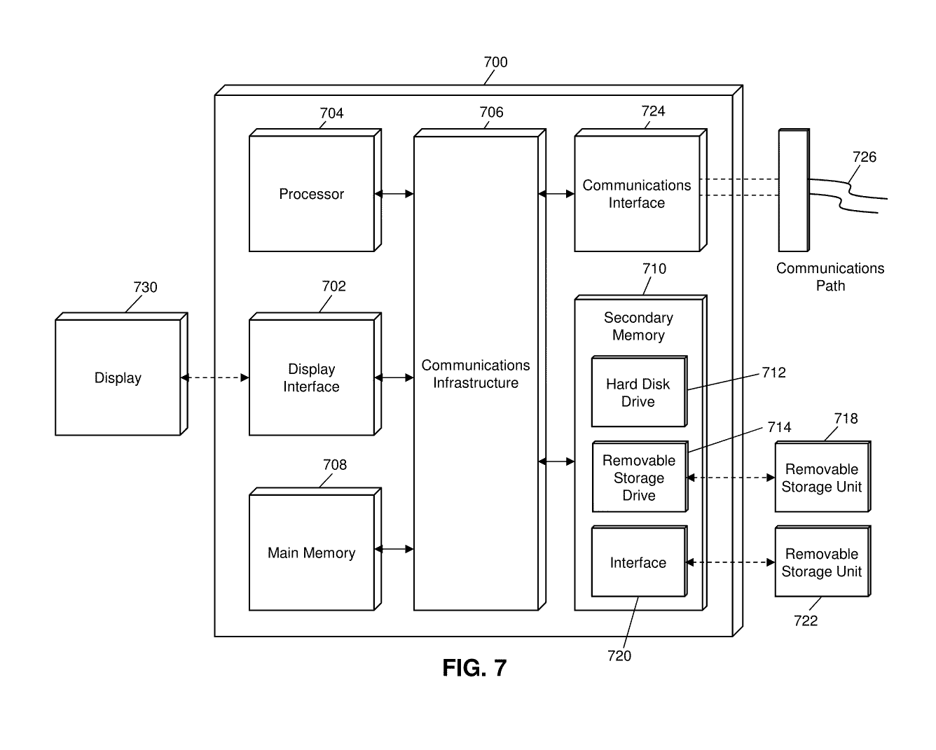

FIG. 2 illustrates an embodiment of the processing server 106 of the system 100. It will be apparent to persons having skill in the relevant art that the embodiment of the processing server 106 illustrated in FIG. 2 is provided as illustration only and may not be exhaustive to all possible configurations of the processing server 106 suitable for performing the functions as discussed herein. For example, the computer system 700 illustrated in FIG. 7 and discussed in more detail below may be a suitable configuration of the processing server 106.

The processing server 106 may include an account database 208. The account database 208 may include a plurality of account profiles 210. Each account profile 210 may be configured to store data related to a consumer 102 including at least an account identifier. The account identifier may be a unique value suitable for use in identifying the account profile 210 and/or the related consumer 102, such as a transaction account number, identification number, username, e-mail address, phone number, loyalty number, device identifier, etc.

The processing server 106 may further include a receiving unit 202. The receiving unit 202 may be configured to receive data over one or more networks via one or more network protocols. The receiving unit 202 may receive payment details associated with a transaction account used to fund one or more payment transactions involving the consumer 102. In some instances, the payment details may be read by one or more input devices interfaced with the receiving unit 202. For example, the payment details may be read from a magnetic stripe or via near field communication from the payment card 104. The payment details may then be received at the receiving unit 202 of the processing server 106 using methods and systems that will be apparent to persons having skill in the relevant art.

The processing server 106 may also include a processing unit 204. The processing unit 204 may be configured to perform the functions of the processing server 106 discussed herein as will be apparent to persons having skill in the relevant art. The processing unit 204 may be configured to identify an account profile 210 in the account database 208 corresponding to received payment details. For example, the processing unit 204 may execute a query on the account database 208 to identify an account profile 210 whose included account identifier corresponds to the account identifier included in corresponding data received by the receiving unit 202. If no account profile 210 exists, the processing unit 204 may be configured to generate a new account profile 210. The account identifier may be identified using the received payment details, or may be received separately as provided by the consumer 102 (e.g., and input via the consumer 102 or an employee of the merchant). The processing unit 204 may also store the received payment details in the account profile 210 for use in an aggregated payment transaction.

The processing server 106 may further include a transmitting unit 206. The transmitting unit 206 may be configured to transmit a request for a trustworthiness score, such as to the payment network 106. The request may include at least the account identifier included in the account profile 210 identified and/or generated by the processing unit 204 that is related to the consumer 102. The payment network 106 or other third party may then identify a trustworthiness score for the consumer 102 based on the consumer's 102 transaction history, purchase behavior, credit score, risk score, fraud score, and/or other suitable information. The payment network 106 may transmit the trustworthiness score in response to the transmitted request, which may be received by the receiving unit 202. In some embodiments, the processing unit 204 may store the trustworthiness score in the account profile 210. In such an instance, the processing server 106 may not need to request a trustworthiness score for the consumer 102 for future transactions. In some cases, the processing server 106 may regularly request and/or receive updated trustworthiness scores.

The processing unit 204 may then identify an aggregation period for the consumer 102 based on the received trustworthiness score. In some instances, the aggregation period may be based on one or more rules, which may be stored in a memory 212. The memory 212 may be configured to store the aggregation rules and any other data suitable for performing the functions disclosed herein. The aggregation rules, such as illustrated in FIG. 3 and discussed below, may include one or more rules and/or algorithms for identifying an aggregation period for a particular consumer 102 based on the consumer's 102 trustworthiness score. In some embodiments, the identified aggregation period may be stored in the account profile 210.

The receiving unit 202 may be configured to receive transaction data for a plurality of payment transactions involving the consumer 102. The processing unit 204 may be configured to aggregate the received transaction data until the aggregation period for the consumer 102 (e.g., as previously identified and stored in the corresponding account profile 210) has expired. Once the period has expired, the processing unit 204 may identify an aggregated payment transaction using methods that will be apparent to persons having skill in the relevant art, such as adding up the transaction amount for each of the plurality of payment transactions. The transmitting unit 206 may then transmit the aggregated transaction data to the payment network 108 (e.g., via an acquiring bank) for processing of the aggregated payment transaction.

In embodiments where the aggregation of payment transactions may be further based on the aggregated transaction amount and/or consumer preferences, the processing unit 204 may be configured to aggregate the payment transactions accordingly. For instance, if the consumer 102 specifies a maximum period of time for aggregation (e.g., with such data being received by the receiving unit 202), the maximum period may be stored in the account profile 210 and identified by the processing unit 204 for use in the aggregation of the payment transaction. In instances where a maximum amount may be used, the processing unit 204 may be configured to aggregate payment transactions involving the consumer 102 until the amount is satisfied.

In some embodiments, the processing unit 204 may be configured to calculate trustworthiness scores. In such an embodiment, each account profile 210 may include additional data associated with the related consumer 102, such as transaction history, credit scores, etc. The processing unit 204 may then use the data included in the account profile 210 to calculate a trustworthiness score for the related consumer 102 based thereon.

### Identification of Aggregation Periods Based on Account Trustworthiness

FIG. 3 illustrates the identification of aggregation periods for consumers 102 based on the account trustworthiness of each consumer 102.

Table 300 illustrates example aggregation rules and/or algorithms, such as may be stored in the memory 212 of the processing server 106 and used by the processing unit 204 to identify aggregation periods for consumers 102 based on their account trustworthiness scores. The table 300 illustrates ranges of trustworthiness scores and their corresponding aggregation periods to be used for the consumer 102 based on the trustworthiness score. For example, the algorithms state that a consumer 102 with a trustworthiness score between 33 and 34, on a scale from 0 to 100, would have an aggregation period of 2 days for which payment transactions were aggregated before an aggregated payment transaction processed.

While the table 300 illustrated in FIG. 3 illustrates the trustworthiness score as a number between 0 and 100, it will be apparent to persons having skill in the relevant art that different scores or metrics suitable for rating, ranking, and/or scoring a consumer may be used. For example, the trustworthiness score may be a credit score (e.g., between 300 and 850), a rating (e.g., Very Poor, Poor, Average, Good, Very Good, etc.), ranking (e.g., bottom 10%, bottom 25%, middle 50%, top 25%, top 10%, etc.), etc.

Table 302 illustrates a plurality of consumers 102 and their trustworthiness scores, and their subsequently identified aggregation periods based on their trustworthiness scores and the algorithms included in table 300. For example, consumer 1 has a trustworthiness score of 97, which, according to the table 300, corresponds to an aggregation period of 7 days. Accordingly, payment transactions involving consumer 1 may be aggregated by the processing server 106 for a period of 7 days before a single, aggregated payment transaction is processed. Conversely, consumer 2, with a trustworthiness score of only 26, may have their payment transactions aggregated daily due to their being less trustworthy than consumer 1, such as due to a lower credit score, lack of transaction history, etc.

In some embodiments, the trustworthiness score and/or subsequently identified aggregation period may be variable for each consumer. For example, the trustworthiness score for a consumer may be regularly calculated and/or identified, such as on a rolling 30-day basis, such that each day, week, etc. the aggregation period may be changed based on their changing trustworthiness score. In such an embodiment, the aggregation score may be based on application of the table 300 to their updated trustworthiness score. In some instances, the algorithms used to identify aggregation period may take into account changes in trustworthiness score. For example, a consumer whose trustworthiness score goes from 20 to 40 in an update may be provided with a longer aggregation period than another consumer whose trustworthiness score goes from 60 to 40 in the update, as the change in score itself may have an implication on the consumer's trustworthiness.

As such, changes in the trustworthiness scores may be reflected in the aggregation algorithms. In an example, the table 300 may include three different aggregation periods for each score range. For instance, the algorithms may indicate that a consumer with a consistent trustworthiness score of 35 have a 2 day aggregation period, while a consumer whose score is 35 from previously being 55 may be provided a 60 hour aggregation period, while another consumer whose score is 35 from previously being 15 may be provided a 36 hour aggregation period.

### Process for Intelligent Aggregation of Payment Transactions

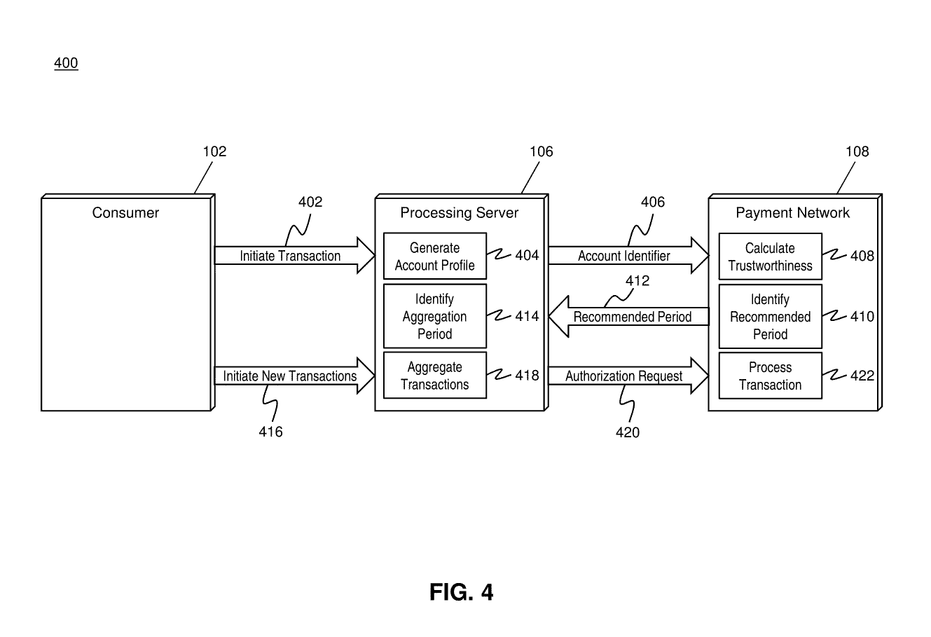

FIG. 4 illustrates a process 400 for the intelligent aggregation of payment transactions using the system 100.

In step 402, the consumer 102 may initiate a first payment transaction with the merchant. As part of the initiation of the payment transaction, the receiving unit 202 of the processing server 106 of the merchant may receive payment details for the payment transaction, which may include an account identifier for the consumer 102, such as a transaction account number. In step 404, the processing unit 204 of the processing server 106 may generate an account profile 210 for the consumer 102 that includes the account identifier, or may identify a pre-existing account profile 210 including the account identifier via the execution of a query on the account database 208 to identify the account profile 210. The identified and/or generated account profile 210 may also include the payment details provided by the consumer 102 for funding of the payment transaction.

In step 406, the transmitting unit 206 of the processing server 106 may transmit the account identifier to the payment network 108. In some instances, the account identifier may be transmitted via the payment rails, such as in a data element of a transaction message. In other instances, an alternative communication network may be used, such as the Internet. The payment network 108 may receive the account identifier, and, in step 408, may calculate a trustworthiness score for the consumer 102 based on data associated with the consumer 102, such as their credit score, a fraud score, transaction history, purchase behavior, an estimated risk score for the initial payment transaction, etc. In step 410, the payment network 108 may identify a recommended aggregation period to be used for the consumer 102, such as based on the trustworthiness score, the merchant or an industry of the merchant, etc. It will be apparent to persons having skill in the relevant art that step 410 may be an optional step.

In step 412, the payment network 108 may transmit the consumer's 102 calculated trustworthiness score and/or recommended aggregation period to the processing server 106. The receiving unit 202 may receive the information from the payment network 108, and, in step 414, the processing unit 204 may identify the actual aggregation period for the consumer 102 to be used based on at least the trustworthiness score.

In step 416, the consumer 102 may initiate new payment transactions during the identified aggregation period. The receiving unit 202 may receive the transaction data for each of the new payment transactions, which may be stored in the memory 212 and/or the corresponding account profile 210. Once the aggregation period has expired, then, in step 418, the processing unit 204 may aggregate the payment transactions into a single, aggregated payment transaction, which may include the generation of an authorization request for the aggregated payment transaction. The authorization request may be a transaction message formatted pursuant to one or more associated standards, such as the ISO 8583 standard. The transaction message may include a plurality of data elements, including a data element configured to store the account identifier and another data element configured to store the aggregated transaction amount. In some instances, the transaction message may include a message type indicator indicative of the message being an authorization request. In step 420, the transmitting unit 206 may transmit the generated authorization request to the payment network 108 via the payment rails for processing. In step 422, the payment network 108 may process the aggregated payment transaction using methods and systems that will be apparent to persons having skill in the relevant art.

### Method for Intelligent Aggregation of Payment Transactions

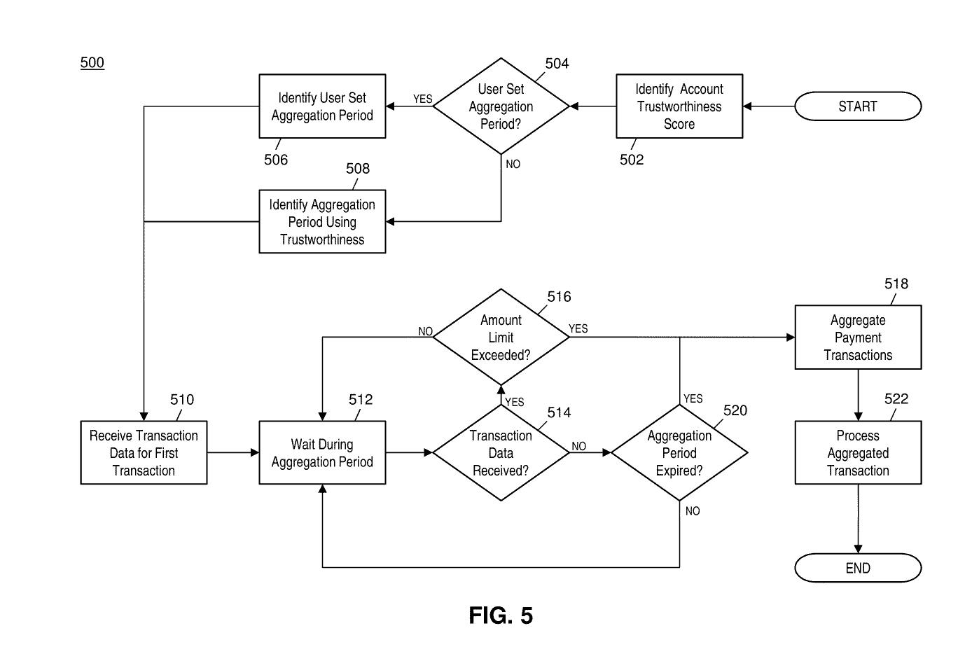

FIG. 5 illustrates a method 500 for the intelligent aggregation of payment transactions using the processing server 106 of FIG. 2.

In step 502, the processing unit 204 may identify a trustworthiness score for an account profile 210 associated with the consumer 102. In some embodiments, the trustworthiness score may be received by the receiving unit 202, such as from the payment network 108. In other embodiments, the processing unit 204 may calculate the trustworthiness score based on data stored in the account profile 210, such as credit scores, risk scores, fraud scores, transaction history, purchase behavior, etc. In step 504, the processing unit 204 may determine if the consumer 102 has requested a specific aggregation period.

If the consumer 102 has specified an aggregation period to be used, then, in step 506, the processing unit 204 may identify the aggregation period set by the consumer 102 for use in the aggregation of future payment transactions involving the consumer 102. If the consumer 102 has not specified an aggregation period, then, in step 508, the processing unit 204 may identify an aggregation period to be used based on application of one or more aggregation rules and/or algorithms, such as illustrated in FIG. 3 and discussed above, to the trustworthiness score identified for the consumer 102. In some embodiments, the processing unit 204 may perform both step 506 and 508 and use the shorter of the two periods.

Once the aggregation period to be used has been identified, then, in step 510, the receiving unit 202 may receive transaction data for a first payment transaction involving the consumer 102. In step 512, the processing unit 204 may wait to proceed during the previously identified aggregation period. In step 514, the processing unit 204 may determine if transaction data for another payment transaction involving the consumer 102 has been received by the receiving unit 202. If a new transaction has been initiated and the transaction data received, then, in step 516, the processing unit 204 may determine if an aggregation limit has been reached based on the transaction amount for the payment transaction.

If no amount limit has been reached, then, the method 500 may return to step 512 where the processing unit 204 may wait for additional transactions or for the period to expire. If the limit has been reached, then the method 500 may proceed to step 518 where the processing unit 204 may aggregate the payment transactions into a single, aggregated payment transaction.

If, in step 514, the processing unit 204 is waiting and no transaction data for a n additional payment transaction has been received, then, in step 520, the processing unit 204 may determine if the identified aggregation period has expired. If the aggregation period has not expired, then the method 500 may return to step 512. If the aggregation period has expired, then the method 500 may proceed to step 518 where the processing unit 204 may aggregate the payment transactions into the single, aggregated payment transaction.

Once an aggregated payment transaction has been created by the processing unit 204, then, in step 522, the aggregated payment transaction may be processed. Processing of the aggregated payment transaction may include transmitting of transaction data for the aggregated payment transaction to the payment network 108 for processing using traditional methods and systems that will be apparent to persons having skill in the relevant art.

### Exemplary Method for Intelligently Aggregating Payment Transactions Based on Consumer Trustworthiness

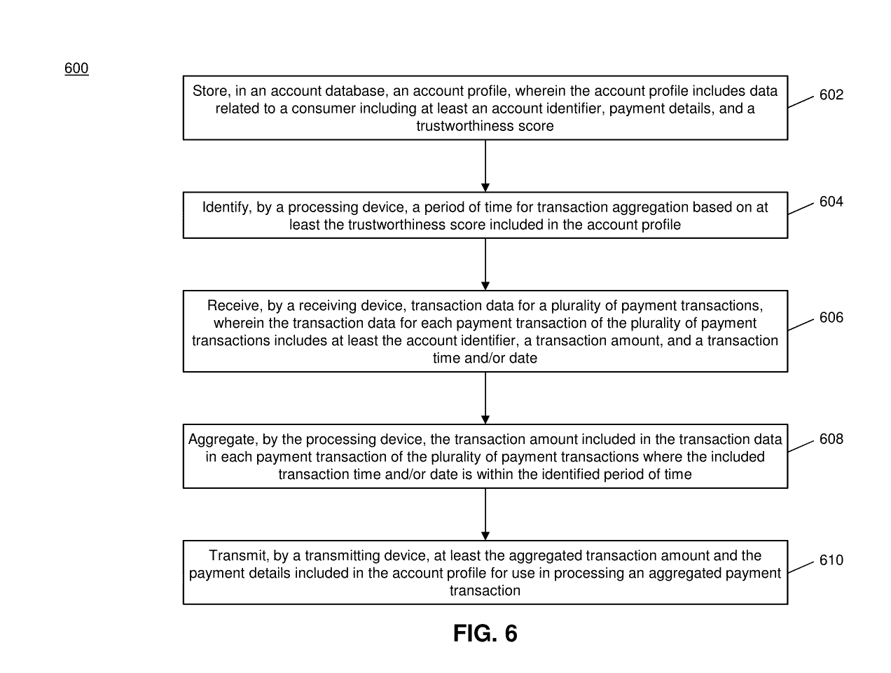

FIG. 6 illustrates a method 600 for the intelligent aggregation of payment transactions based on consumer trustworthiness.

In step 602, an account profile (e.g., the account profile 210) may be stored in an account database (e.g., the account database 208), wherein the account profile 210 includes data related to a consumer (e.g., the consumer 102) including at least an account identifier, payment details, and a trustworthiness score. In one embodiment, the trustworthiness score may be based on at least one of: a credit score, one or more purchase behaviors, a risk score, a fraud score, a transaction history with one or more merchants, and a transaction history with a merchant involved in each payment transaction of the plurality of payment transactions associated with the related consumer 102.

In step 604, a period of time for transaction aggregation may be identified by a processing device (e.g., the processing unit 204) based on at least the trustworthiness score included in the account profile 210. In one embodiment, the identified period of time may be further based on at least one of: an industry or category of a merchant involved in each payment transaction of the plurality of payment transactions, one or more consumer preferences, purchase behavior of the related consumer, and merchant preferences.

In step 606, transaction data may be received by a receiving device (e.g., the receiving unit 202) for a plurality of payment transactions, wherein the transaction data for each payment transaction of the plurality of payment transactions includes at least the account identifier, a transaction amount, and a transaction time and/or date.

In step 608, the processing device 204 may aggregate the transaction amount included in the transaction data in each payment transaction of the plurality of payment transactions where the included transaction time and/or date is within the identified period of time. In some embodiments, aggregating the transaction amount included in the transaction data in each payment transaction of the plurality of payment transactions includes aggregating the transaction amounts into two or more separate transaction amounts if the aggregated transaction amount exceeds a predetermined amount limit. In a further embodiment, the predetermined amount limit may be based on at least one of: an industry or category of a merchant involved in each payment transaction of the plurality of payment transactions, one or more consumer preferences, purchase behavior of the related consumer 102, and merchant preferences.

In step 610, at least the aggregated transaction amount and the payment details included in the account profile 210 may be transmitted, by a transmitting device (e.g., the transmitting unit 206), for use in processing an aggregated payment transaction. In embodiments where the aggregated transaction amount may be aggregated into two or more separate transaction amounts, transmitting the aggregated transaction amount may include transmitting each of the two or more separate transaction amounts for use in processing two or more respective aggregated payment transactions.

In one embodiment, the method 600 may further include receiving, by the receiving device 202, a period recommendation based on at least purchase behavior associated with the related consumer 102, wherein the period of time is further based on the received period recommendation. In some embodiments, the trustworthiness score may be received, by the receiving device 202, from a third party and is based on at least one of: transaction data associated with a merchant involved in each payment transaction of the plurality of payment transactions and the related consumer 102.

In one embodiment, the method 600 may also include storing, in the account profile 210, a plurality of transaction data entries, wherein each transaction data entry includes data related to a payment transaction involving the related consumer 102 including at least transaction data and merchant data. In a further embodiment, the method 600 may even further include calculating, by the processing device 204, the trustworthiness score based on at least the transaction data included in one or more transaction data entries stored in the account profile 210. In another further embodiment, the period of time for transaction aggregation may be further based on at least the transaction data included in one or more transaction data entries stored in the account profile 210.

### Computer System Architecture

FIG. 7 illustrates a computer system 700 in which embodiments of the present disclosure, or portions thereof, may be implemented as computer-readable code. For example, the processing server 106 of FIG. 1 may be implemented in the computer system 700 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 4-6.

If programmable logic is used, such logic may execute on a commercially available processing platform or a special purpose device. A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 718, a removable storage unit 722, and a hard disk installed in hard disk drive 712.

Various embodiments of the present disclosure are described in terms of this example computer system 700. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 704 may be a special purpose or a general purpose processor device. The processor device 704 may be connected to a communications infrastructure 706, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 700 may also include a main memory 708 (e.g., random access memory, read-only memory, etc.), and may also include a secondary memory 710. The secondary memory 710 may include the hard disk drive 712 and a removable storage drive 714, such as a floppy disk drive, a magnetic tape drive, an optical disk drive, a flash memory, etc.

The removable storage drive 714 may read from and/or write to the removable storage unit 718 in a well-known manner. The removable storage unit 718 may include a removable storage media that may be read by and written to by the removable storage drive 714. For example, if the removable storage drive 714 is a floppy disk drive or universal serial bus port, the removable storage unit 718 may be a floppy disk or portable flash drive, respectively. In one embodiment, the removable storage unit 718 may be non-transitory computer readable recording media.

In some embodiments, the secondary memory 710 may include alternative means for allowing computer programs or other instructions to be loaded into the computer system 700, for example, the removable storage unit 722 and an interface 720. Examples of such means may include a program cartridge and cartridge interface (e.g., as found in video game systems), a removable memory chip (e.g., EEPROM, PROM, etc.) and associated socket, and other removable storage units 722 and interfaces 720 as will be apparent to persons having skill in the relevant art.

Data stored in the computer system 700 (e.g., in the main memory 708 and/or the secondary memory 710) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 700 may also include a communications interface 724. The communications interface 724 may be configured to allow software and data to be transferred between the computer system 700 and external devices. Exemplary communications interfaces 724 may include a modem, a network interface (e.g., an Ethernet card), a communications port, a PCMCIA slot and card, etc. Software and data transferred via the communications interface 724 may be in the form of signals, which may be electronic, electromagnetic, optical, or other signals as will be apparent to persons having skill in the relevant art. The signals may travel via a communications path 726, which may be configured to carry the signals and may be implemented using wire, cable, fiber optics, a phone line, a cellular phone link, a radio frequency link, etc.

The computer system 700 may further include a display interface 702. The display interface 702 may be configured to allow data to be transferred between the computer system 700 and external display 730. Exemplary display interfaces 702 may include high-definition multimedia interface (HDMI), digital visual interface (DVI), video graphics array (VGA), etc. The display 730 may be any suitable type of display for displaying data transmitted via the display interface 702 of the computer system 700, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 708 and secondary memory 710, which may be memory semiconductors (e.g., DRAMs, etc.). These computer program products may be means for providing software to the computer system 700. Computer programs (e.g., computer control logic) may be stored in the main memory 708 and/or the secondary memory 710. Computer programs may also be received via the communications interface 724. Such computer programs, when executed, may enable computer system 700 to implement the present methods as discussed herein. In particular, the computer programs, when executed, may enable processor device 704 to implement the methods illustrated by FIGS. 4-6, as discussed herein. Accordingly, such computer programs may represent controllers of the computer system 700. Where the present disclosure is implemented using software, the software may be stored in a computer program product and loaded into the computer system 700 using the removable storage drive 714, interface 720, and hard disk drive 712, or communications interface 724.

Techniques consistent with the present disclosure provide, among other features, systems and methods intelligently aggregating payment transactions based on consumer trustworthiness. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for intelligently aggregating payment transactions based on consumer trustworthiness, comprising:
storing, in an account database, an account profile, wherein the account profile includes data related to a consumer including at least an account identifier, payment details, and a trustworthiness score;
identifying, by a processing device, a period of time for transaction aggregation based on at least the trustworthiness score included in the account profile;
receiving, by a receiving device, transaction data for a plurality of payment transactions, wherein the transaction data for each payment transaction of the plurality of payment transactions includes at least the account identifier, a transaction amount, and a transaction time and/or date;
aggregating, by the processing device, the transaction amount included in the transaction data in each payment transaction of the plurality of payment transactions where the included transaction time and/or date is within the identified period of time; and
transmitting, by a transmitting device, at least the aggregated transaction amount and the payment details included in the account profile for use in processing an aggregated payment transaction.

2. The method of claim 1, wherein the identified period of time for transaction aggregation is further based on at least one of: an industry or category of a merchant involved in each payment transaction of the plurality of payment transactions, one or more consumer preferences, purchase behavior of the related consumer, and merchant preferences.

3. The method of claim 1, further comprising:
receiving, by the receiving device, a period recommendation based on at least purchase behavior associated with the related consumer, wherein
the period of time for transaction aggregation is further based on the received period recommendation.

4. The method of claim 1, wherein the trustworthiness score is based on at least one of: a credit score, one or more purchase behaviors, a risk score, a fraud score, a transaction history with one or more merchants, and a transaction history with a merchant involved in each payment transaction of the plurality of payment transactions associated with the related consumer.

5. The method of claim 1, wherein the trustworthiness score is received, by the receiving device, from a third party and is based on at least one of: transaction data associated with a merchant involved in each payment transaction of the plurality of payment transactions and the related consumer.

6. The method of claim 1, wherein aggregating the transaction amount included in the transaction data in each payment transaction of the plurality of payment transactions includes aggregating the transaction amounts into two or more separate transaction amounts if the aggregated transaction amounts exceeds a predetermined amount limit.

7. The method of claim 6, wherein the predetermined amount limit is based on at least one of: an industry or category of a merchant involved in each payment transaction of the plurality of payment transactions, one or more consumer preferences, purchase behavior of the related consumer, and merchant preferences.

8. The method of claim 6, wherein transmitting the aggregated transaction amount includes transmitting each of the two or more separate transaction amounts for use in processing two or more respective aggregated payment transactions.

9. The method of claim 1, further comprising:
storing, in the account profile, a plurality of transaction data entries, wherein each transaction data entry includes data related to a payment transaction involving the related consumer including at least transaction data and merchant data.

10. The method of claim 9, further comprising:
calculating, by the processing device, the trustworthiness score based on at least the transaction data included in one or more transaction data entries stored in the account profile.

11. The method of claim 9, wherein the period of time for transaction aggregation is further based on at least the transaction data included in one or more transaction data entries stored in the account profile.

12. A system for intelligently aggregating payment transactions based on consumer trustworthiness, comprising:
an account database configured to store an account profile, wherein the account profile includes data related to a consumer including at least an account identifier, payment details, and a trustworthiness score;
a processing device configured to identify a period of time for transaction aggregation based on at least the trustworthiness score included in the account profile;
a receiving device configured to receive transaction data for a plurality of payment transactions, wherein the transaction data for each payment transaction of the plurality of payment transactions includes at least the account identifier, a transaction amount, and a transaction time and/or date; and
a transmitting device, wherein
the processing device is further configured to aggregate the transaction amount included in the transaction data in each payment transaction of the plurality of payment transactions where the included transaction time and/or date is within the identified period of time, and
the transmitting device is configured to transmit at least the aggregated transaction amount and the payment details included in the account profile for use in processing an aggregated payment transaction.

13. The system of claim 12, wherein the identified period of time for transaction aggregation is further based on at least one of: an industry or category of a merchant involved in each payment transaction of the plurality of payment transactions, one or more consumer preferences, purchase behavior of the related consumer, and merchant preferences.

14. The system of claim 12, wherein
the receiving device is further configured to receive a period recommendation based on at least purchase behavior associated with the related consumer, and
the period of time for transaction aggregation is further based on the received period recommendation.

15. The system of claim 12, wherein the trustworthiness score is based on at least one of: a credit score, one or more purchase behaviors, a risk score, a fraud score, a transaction history with one or more merchants, and a transaction history with a merchant involved in each payment transaction of the plurality of payment transactions associated with the related consumer.

16. The system of claim 12, wherein the trustworthiness score is received, by the receiving device, from a third party and is based on at least one of: transaction data associated with a merchant involved in each payment transaction of the plurality of payment transactions and the related consumer.

17. The system of claim 12, wherein aggregating the transaction amount included in the transaction data in each payment transaction of the plurality of payment transactions includes aggregating the transaction amounts into two or more separate transaction amounts if the aggregated transaction amounts exceeds a predetermined amount limit.

18. The system of claim 17, wherein the predetermined amount limit is based on at least one of: an industry or category of a merchant involved in each payment transaction of the plurality of payment transactions, one or more consumer preferences, purchase behavior of the related consumer, and merchant preferences.

19. The system of claim 17, wherein transmitting the aggregated transaction amount includes transmitting each of the two or more separate transaction amounts for use in processing two or more respective aggregated payment transactions.

20. The system of claim 12, wherein the account database is further configured to store, in the account profile, a plurality of transaction data entries, wherein each transaction data entry includes data related to a payment transaction involving the related consumer including at least transaction data and merchant data.

21. The system of claim 20, wherein the processing device is further configured to calculate the trustworthiness score based on at least the transaction data included in one or more transaction data entries stored in the account profile.

22. The system of claim 20, wherein the period of time for transaction aggregation is further based on at least the transaction data included in one or more transaction data entries stored in the account profile.
